(19) United States
(12) Patent Application Publication
(10) Pub. No.: US 2008/0085624 A1
(43) Pub. Date: Apr. 10, 2008

(54) EXTENDED DIMM SOCKET GUIDES FOR DIMM RETENTION

(75) Inventors: Charles C. Gange, Rhinebeck, NY (US); Timothy A. Meserth, Durham, NC (US); Tony C. Sass, Fuquay Varina, NC (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/538,875

(22) Filed: Oct. 5, 2006

(51) Int. Cl. H01R 13/64

(52) U.S. Cl. 439/377

(57) ABSTRACT

A socket for receiving a memory module is provided and includes a receiving area having a plurality of socket contacts for making contact with a plurality of memory module contacts and a set of guiding tracks disposed at each end of the socket, wherein the guiding tracks including at least one feature for retaining the memory module once the memory module is dismounted from the socket. A method for fabricating the socket is provided.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to installation of memory and particularly to apparatus for installation and retention of Dual Inline Memory Modules (DIMM).

2. Description of the Related Art

DIMMs (Dual inline memory modules) are a standard part of most consumer and industrial computing devices. Whether used in personal computing devices or mainframe computers, memory modules are critical for the machine to function properly. When a memory module fails to perform, removal and replacement of the defective memory module is required for the machine to continue to operate as intended. Upgrading or adding additional memory modules to a machine is a commonplace activity that allows users to modify the computing device to fit changing requirements or perform system maintenance. Memory modules are one of the more frequently handled components of a typical computing device.

DIMMs are sensitive to stray static electricity, as are many electronic devices. Careful handling is needed to avoid dropping, bending, or otherwise physically stressing and damaging the memory module. Careless handling can permanently damage the memory module and render it useless. Unfortunately, and contrary to the desired goal for exercise of care when handling each DIMM, existing sockets do not provide for totally secure disengagement of the DIMM from the socket.

Further, to release the DIMM from the socket, ejector levers, typically located on each end of the socket, are usually operated at the same time. In many instances, this results in ejection of the DIMM from the socket with enough force to cause the DIMM to completely disengage from the socket and fall against other sensitive electronic components. In computers configured as desk side towers or as enterprise class servers, the board having the sockets for mounting the DIMM may be in a vertical position. In this instance, handling problems are compounded. For example, ejecting the DIMM may actually cause the DIMM to fall out of the case and onto the floor or some other part of the machine, greatly increasing the risk of damage. Since some memory modules are custom designed and developed for their particular application, damage to a single memory module can be a very costly proposition.

Further, careful handling of the DIMM during removal and replacement is frequently made difficult by the placement and nature of the socket. Often, the sockets are positioned closely together, with only a millimeter or two of clearance between each socket. In many computers where signal integrity is critical, a fit between the DIMM and the socket is very tight. The tight fit results in a high plugging force needed to properly seat the DIMM into the socket. For human hands, this can be a difficult task.

Ejecting DIMMs from sockets, such as those used for the current design of eCLipz i,p, and zSeries HE machines may cause the DIMM to drop out of the machine case onto the floor, typically causing damage to the DIMM. Although DIMMs come in a variety of shapes and sizes, they are frequently attached to a riser card or motherboard using a DIMM socket, such as the one as shown in FIG. 1.

What are needed are improvements to apparatus and techniques for installing DIMM and retaining the installed DIMM.

### SUMMARY OF THE INVENTION

The shortcomings of the prior art are overcome and additional advantages are provided through the provision of a socket for receiving a memory module, the socket including: a receiving area having a plurality of socket contacts for making contact with a plurality of memory module contacts and a set of guiding tracks disposed at each end of the socket, wherein the guiding tracks including at least one feature for retaining the memory module once the memory module is dismounted from the socket.

Also disclosed is a method for fabricating a socket for a memory module, the method including: providing a receiving area having a plurality of socket contacts for making contact with a plurality of memory module contacts; determining at least one feature for retaining the memory module once the memory module is dismounted from the socket; and including at least one feature into guiding tracks disposed at each end of the socket.

A socket for receiving a memory module including a dual inline memory module (DIMM), the socket including: a receiving area having a plurality of socket contacts for making contact with a plurality of DIMM contacts and a set of guiding tracks disposed at each end of the socket, wherein the guiding tracks including at least one feature for retaining the DIMM once the DIMM is dismounted from the socket, the feature including at least one of length of the guiding tracks, distance between the guiding tracks, a coefficient of friction between the guiding tracks and the DIMM, and identifying at least one brace between the guiding tracks.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a prior art socket for receiving a Dual Inline Memory Module (DIMM);

FIG. 2 illustrates aspects of a DIMM;

FIG. 3 provides a side view of the prior art socket;

FIG. 4 provides a side view of an improved socket according to the teachings herein;

FIG. 5 depicts an end view of one embodiment of the improved socket;

FIG. 6 depicts an end view of another embodiment of the improved socket; and

FIG. 7 depicts an end view of a further embodiment of the improved socket.

The detailed description explains the preferred embodiments of the invention, together with advantages and features, by way of example with reference to the drawings.

### DETAILED DESCRIPTION OF THE INVENTION

A guiding principle of good ergonomic design is to make the machine fit the person, not ask the person to fit the machine. Since operation of the ejector levers on the DIMM socket requires a person to use both hands there is no way for that person to make sure the memory module does not damage other components in the machine or fall out of the case when it is ejected from the socket. Considering the restricted space where DIMMs are usually installed, having a second person involved in the process is impractical. Introducing a tool for use during the removal or replacement of the DIMM would further complicate the activity. The solution provided herein would introduce no further requirements on the person trying to remove the DIMM, but instead be designed into the machine as an unobtrusive aid to completing the task.

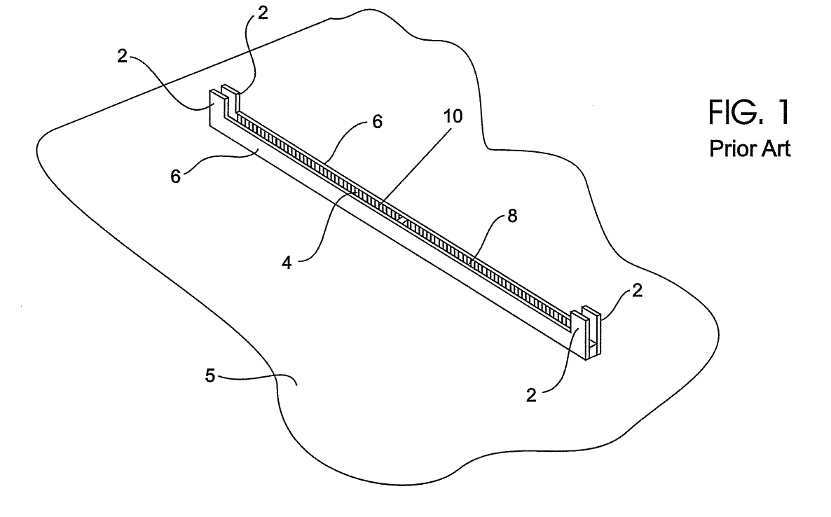

Referring now to FIG. 1, there is shown a socket 10 for receiving a Dual Inline Memory Module (DIMM). The socket 10 includes a receiving area 4 into which the DIMM is inserted. The receiving area 4 includes walls 6 between which is provided a plurality of socket contacts 8 for making contact with contacts of the DIMM. Once the DIMM is set into the receiving area 4, communication with the DIMM is provided for through the plurality of socket contacts 8. Typically, the socket 10, as well as the enhanced socket disclosed herein, are mounted on a board 5, such as a motherboard. As techniques for coupling of sockets and communication therewith are known in the art, these topics are generally not discussed further herein.

The socket 10 of the prior art includes two guides 2, with each one of the guides 2 being disposed at an end of the receiving area 4. The guides 2 generally provide support for the DIMM. That is, the guides 2, in addition to guiding the DIMM into the receiving area 4 during insertion thereof, also provide for maintaining the DIMM in a desired orientation when installed into the receiving area 4. As one example, the DIMM is maintained in a generally perpendicular orientation to the board 5 to which the socket 10 is mounted. Typically, each of the guides 2 is only somewhat taller than the walls 6 of the receiving area 4. Typically, each guide 2 includes a wall on each side of the socket 10.

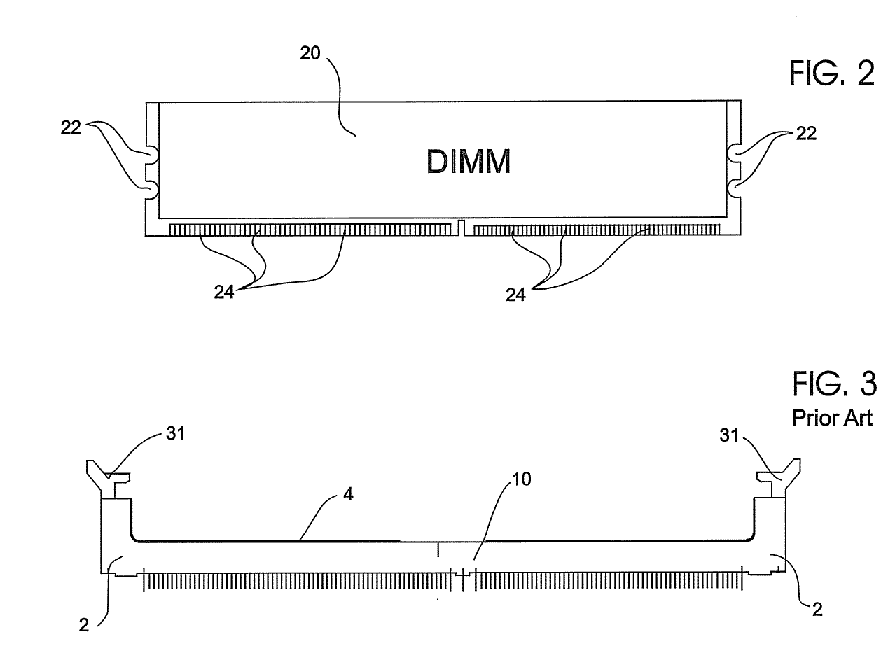

Referring now to FIG. 2, there is shown a Dual Inline Memory Module (DIMM) 20 useful for combining with the teachings herein. The DIMM 20 includes a plurality of DIMM contacts 24. The plurality of DIMM contacts 24 are received in the receiving area 4 and mate with the plurality of socket contacts 8 to provide for mounting of the DIMM 20.

The notches 22 provide features for grabbing and retaining the DIMM 20 in the socket 10. The grabbing and the retaining are typically accomplished by use of various latching mechanisms. Exemplary prior art latching mechanisms are provided in FIG. 3.

Referring now to FIG. 3, various latching mechanisms are used to secure the DIMM 20 to the socket 10 and maintain a stable connection. One commonly used embodiment incorporates at least one ejector lever 31 into the socket 10 as shown. Each of the ejectors 31 shown in FIG. 3 is depicted in a closed position. Note that the DIMM 20 is not depicted in this illustration. However, one skilled in the art will note that each ejector 31 includes mating portions for mating with the notches 22 of the DIMM 20.

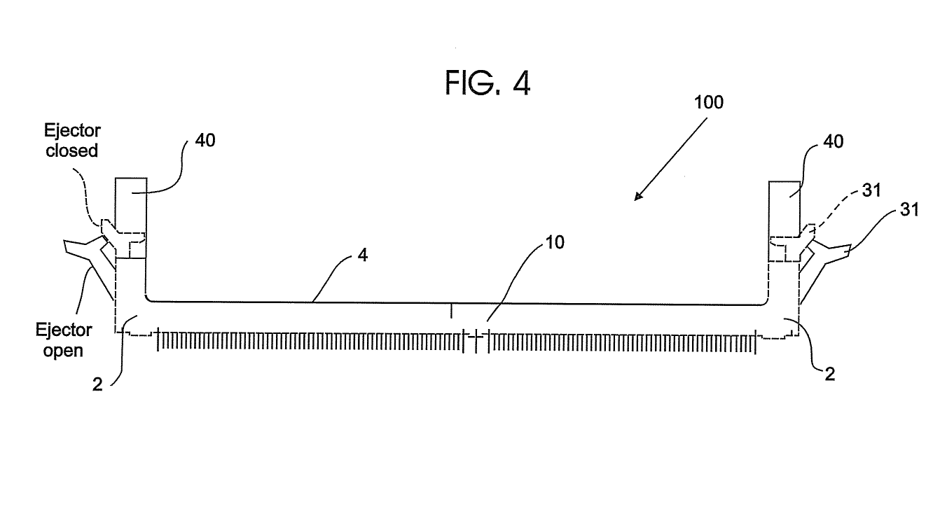

Referring now to FIG. 4, there are shown aspects of an enhanced socket 100. The enhanced socket 100 includes the receiving area 4 having a plurality of contacts and two walls (as depicted in FIG. 1). However, the enhanced socket 100 includes guiding tracks 40, one at each end, to enhance mounting and retention of the DIMM 20. Each of the guiding tracks 40 provides a stabilizing length not found in the prior art. In typical embodiments, the stabilizing length is about fifteen (15) millimeters (mm) or more. In addition to acting as a retention mechanism, the mere presence of the stabilizing length helps to prevent accidental drop out of the DIMM 20. For example, in some embodiments, the stabilizing length provides a source of friction and therefore for frictional retention of the DIMM 20.

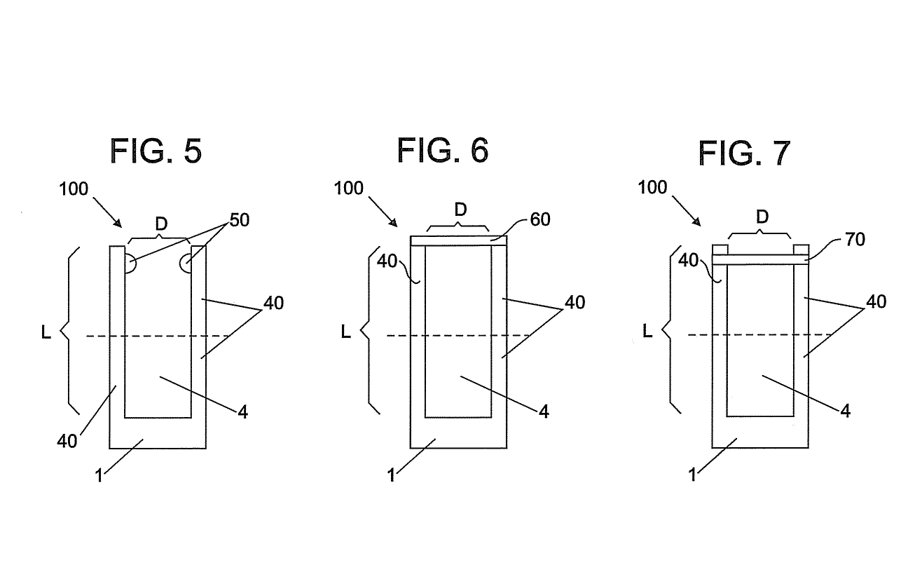

Turning now to FIGS. 5, 6 and 7, end views of various embodiments of the enhanced socket 100 are provided. In each of FIGS. 5, 6 and 7, the enhanced socket 100 includes a base 1 and provides for the receiving area 4. The dashed line in each of these figures depicts a length of prior art guides 2, and is provided for perspective.

In the various embodiments of the enhanced socket 100, the guiding tracks 40 include a stabilizing length, L. The stabilizing length, L, typically supports the DIMM 20 when the DIMM 20 is fully inserted, as well as when the DIMM 20 is dismounted from the receiving area 4. The guiding tracks 40 are typically spaced apart from each other by a distance, D. The distance D can be modified or controlled through various techniques to enhance retention of the DIMM 20. For example, in FIG. 5, at least one dimple 50 is included. The dimple 50 provides for concentrating force and any spring action that results from the guiding track 40 as a lever spring.

In some embodiments, such as those where heavy DIMM 20 are used, the enhanced socket 100 includes a crossbrace stiffener to help maintain consistent clearance between the guiding tracks 40. As an example, in FIG. 6, a top brace 60 may be included. The top brace 60 may be designed to cover a portion of the DIMM 20 when installed. In these embodiments, the DIMM 20 is typically inserted under the top brace 60 and pivotally rotated into the receiving area 4. In other embodiments, the top brace 60 does not impede a straight downward insertion of the DIMM 20 into the enhanced socket 100. In another embodiment depicted in FIG. 7, a side brace 70, is included.

Of course, the guiding tracks 40 may be deployed without dimples 50, top braces 60 and side braces 70. One skilled in the art will recognize that the enhanced socket 100 may be designed around various parameters for each type of DIMM 20. For example, the DIMM height and plugging force required.

Some DIMM cards are quite sizeable, relatively heavy, and subjected to high plugging forces. In those instances the use of a significantly longer guide track is anticipated. Smaller DIMM cards may possibly call for use of shorter guiding tracks 40. Typically, in support of each type of DIMM 20, actual field testing is used to verify proper performance. It is anticipated that heavy cards may require the addition of a crossbrace “stiffener” to help maintain consistent clearance between the longer guide tracks.

One measure for proper performance of the enhanced socket 100 is continued retention of the DIMM 20 when the DIMM 20 is dismounted from the enhanced socket 100. One embodiment of dismounting includes ejecting the DIMM 20. In this case, ejected is taken to mean that the DIMM 20 is completely disengaged from the plurality of socket contacts 8. That is, the guiding tracks 40 ensure retention of the DIMM 20 once the DIMM 20 has been ejected from the receiving area 4. The ensuring occurs by considering, among other things, a length of each guiding track 40, a frictional force between the DIMM 20 and each guiding track 40, and an ejection force that may be required to disengage the DIMM 20 from the respective receiving area 4.

For convention, dismounting and ejection are distinct from “removing” the DIMM 20. In the case of removal of the DIMM 20, a user will actually withdraw the DIMM 20 from the enhanced socket 100. Clearly, removal of the DIMM 20 is required where DIMM 20 are to be exchanged or replaced.

As one example, one or more aspects of the present invention can be included in an article of manufacture (e.g., one or more computer program products) having, for instance, computer usable media. The article of manufacture can be included as a part of a computer system or sold separately.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A socket for receiving a memory module, the socket comprising:
a receiving area having a plurality of socket contacts for making contact with a plurality of memory module contacts and a set of guiding tracks disposed at each end of the socket, wherein the guiding tracks comprise at least one feature for retaining the memory module once the memory module is dismounted from the socket, and the guiding tracks comprise at least one crossbrace stiffener disposed on an exterior portion thereof.

2. The socket as in claim 1, wherein the memory module comprises a dual inline memory module.

3. The socket as in claim 1, wherein the feature comprises a length.

4. The socket as in claim 1, wherein the feature comprises a distance between the guiding tracks.

5. (canceled)

6. The socket as in claim 1, wherein the feature comprises at least one dimple for contacting the memory module.

7. The socket as in claim 1, wherein the feature comprises a coefficient of friction for an installed memory module.

8. A method for fabricating a socket for a memory module, the method comprising:
providing a receiving area having a plurality of socket contacts for making contact with a plurality of memory module contacts;
determining at least one feature for retaining the memory module once the memory module is dismounted from the socket;
including the at least one feature into guiding tracks disposed at each end of the socket; and, disposing a crossbrace stiffener between an exterior portion of the guiding tracks.

9. The method as claim 8, wherein determining comprises determining at least one of length of the guiding tracks, distance between guiding tracks and a coefficient of friction between the guiding tracks and the memory module.

10. A socket for receiving a memory module comprising a dual inline memory module (DIMM), the socket comprising:
a receiving area having a plurality of socket contacts for making contact with a plurality of DIMM contacts and a set of guiding tracks comprising at least one crossbrace stiffener disposed on an exterior side of the guiding tracks, the guiding tracks disposed at each end of the socket, wherein the guiding tracks comprise at least one feature for retaining the DIMM once the DIMM is dismounted from the socket, the feature comprising at least one of length of the guiding tracks, distance between the guiding tracks, a coefficient of friction between the guiding tracks and the DIMM.

11. The socket as in claim 1, wherein the crossbrace stiffener comprises at least one of a top brace and a side brace.
